(19) United States
(12) Patent Application Publication
(10) Pub. No.: US 2023/0051614 A1
(43) Pub. Date: Feb. 16, 2023

(54) DECORATIVE FIGURE

(71) Applicant: RICO DESIGN GmbH & Co. KG, Brakel (DE)

(72) Inventor: Ellen JACOBY, Paderborn (DE)

(73) Assignee: RICO DESIGN GmbH & Co. KG, Brakel (DE)

(21) Appl. No.: 17/400,195

(22) Filed: Aug. 12, 2021

(51) Int. Cl. A63H 3/16; C09J 7/28; G09F 3/10; G09F 3/02

(52) U.S. Cl. CPC A63H 3/16; C09J 7/28; G09F 3/10; G09F 3/02; G09F 2003/0266

(57) ABSTRACT

A decorative figure has a first gel sticker part and a second gel sticker part adhered to each other at an adhesive surface, wherein the first gel sticker part has a decorative side with the image of a front side of a three-dimensional figure and the second gel sticker part has a decorative side with the image of a back side of the three-dimensional figure. A pivotable first flap is provided on the first gel sticker part and a pivotable second flap is provided on the second gel sticker part, and the first flap and the second flap can be fixed to a base, the decorative side on the first and the second gel sticker parts being fixable to the base so as to project upwards.

### BACKGROUND OF THE INVENTION

### 1. Field of the Invention

The present invention relates to a decorative figure having a first gel sticker part and a second gel sticker part adhered to each other on an adhesive surface. Such decorative figures may be used as play figures for children or generally for decorative purposes.

### 2. Description of the Related Art

There are so-called gel stickers, which have an adhesive surface for sticking to a substrate and on the opposite side to the adhesive surface have a decorative side with a decorative image, which is covered with a gel-like coating. As a result, the gel stickers have a plastic, three-dimensional contour and are used for visual enhancement in handicrafts. However, a disadvantage of such gel stickers is that no three-dimensional scenes can be created. Even if two identical gel stickers are stuck together, the front and back sides are formed identically, and there is a lack of lifelike character of a decorative figure assembled in this way. Especially when decorative figures are used on a three-dimensional background, such prefabricated decorative figures look monotonous. In addition, the gel stickers glued together are difficult to fix to a substrate.

### SUMMARY OF THE INVENTION

It is therefore an object of the present invention to provide a decorative figure that has a lifelike appearance and is easily fixable to a substrate.

This object is solved according to the invention with a decorative figure having having a first gel sticker part and a second gel sticker part which adhere to one another on an adhesive surface. The first gel sticker part has a decorative side with an image of a front side of a three-dimensional figure and the second gel sticker part has a decorative side with an image of a back side of the three-dimensional figure. A first pivotable flap is provided on the first gel sticker part and a second pivotable flap is provided on the second gel sticker part, wherein the first flap and the second flap can be fixed to a base and the decorative side on the first and second gel sticker parts can be fixed to the base in an upwardly projecting manner. Due to the different design of the decorative sides on the first gel sticker part and the second gel sticker part, a three-dimensional figure can be depicted from a front side and a back side, so that a three-dimensional effect is created when the decorative figure is set up, since the viewer can look at the decorative figure from two sides.

For example, if the three-dimensional figure is formed as a human being, the face and abdomen may be visible on the front side, while the back of the head and the back are visible on the back side. On the other hand, if a human is depicted from the side, one of the two views is defined as the “front” and the view from the opposite side is defined as the “back”. The same applies to animals or plants, where the terms “front” and “back” can be defined depending on the image. These are views from opposite sides of a three-dimensional figure.

The flaps are preferably oriented substantially perpendicular to the decorative side when the decorative figure is in the erected position. In this case, the flaps can protrude to opposite sides starting from a plane formed by the adhesive surface of the two gel sticker parts.

For stable fixation of the decorative figure to a substrate, the flaps can have a contour that is essentially round in plan view, although other geometries, such as a rectangle, square, semicircle, semi-oval, triangle or irregular geometries can also be used for the flap. Preferably, the flap is flexibly bendable by a reduced gel coating on the flap and directly connected to the decorative side of the first or second gel sticker.

The figure depicted on the two gel sticker parts can, for example, be in the form of a human, animal or plant, in particular a tree, flower or palm tree. In these figures, a view from opposite sides can be seen. In this case, the first gel sticker part and the second gel sticker part can be of the same size, so that they can be glued to one another and no open adhesive area protrudes from the assembled decorative figure. In addition, 2-dimensional sticker motifs, such as a picnic blanket, can also be used.

Each gel sticker part preferably has a printed decorative foil and a transparent coating. The coating can be applied to the decorative foil in the form of an arc in cross-section, so that the decorative figure has a three-dimensional appearance when erected.

For a particularly stable fixation of the decorative figure, several flaps can also be provided on the first and/or second gel sticker part, which can be glued onto a substrate.

According to the invention, a set with several decorative figures is also provided, wherein the individual gel sticker parts of one or more decorative figures are adhered to a carrier foil. The user can then remove these from the carrier foil as required and join them together to form a decorative figure.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1A shows a front view of a decorative figure made of two gel sticker parts;

FIG. 1B shows a rear view of the decorative figure of FIG. 1A;

FIG. 2A shows a front view of another decorative figure made of two gel sticker parts;

FIG. 2B shows a rear view of the decorative figure of FIG. 2A;

FIG. 3A shows a front view of yet another decorative figure made of two gel sticker parts;

FIG. 3B shows a rear view of the decorative figure of FIG. 3A; and

FIG. 4 shows a sectional view through a glued-together decorative figure.

### DETAILED DESCRIPTION OF PREFERRED EMBODIMENTS

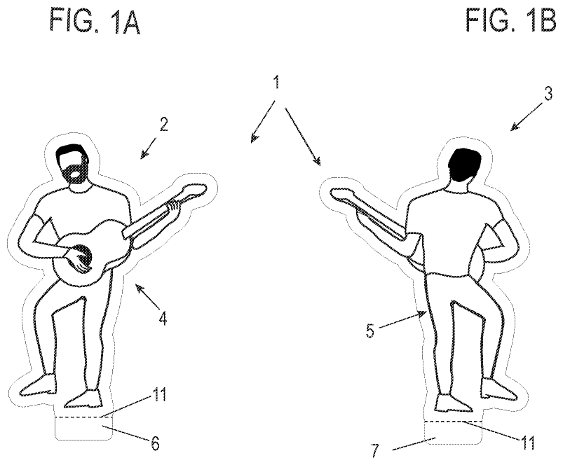

FIGS. 1A and 1B show a decorative figure 1 consisting of two parts, namely a first gel sticker part 2 and a second gel sticker part 3. Both gel sticker parts 2 and 3 are shown with their decorative side, and an adhesive surface is provided on the opposite side in each case so that they can be stuck together.

The first gel sticker part 2 has on the decorative side an image 4 of a front side of a three-dimensional figure in the form of a guitar player. On the front side, the face and the guitar with the hands of the guitar player are visible. In the area of the feet of the guitar player, there is a pivotable first flap 6 which can be pivoted over a dotted folding or bending line.

The second gel sticker part 3 has a decorative side with the image 5 of a back of the three-dimensional figure in the form of the guitar player. The back and back of the head of the guitar player can be seen. In the area of the feet of the guitar player, a second flap 7 is connected to the second gel sticker part 2 by a folding or bending line.

For setting up the decorative figure 1, the first gel sticker part 2 and the second gel sticker part 3 can be peeled off from a carrier foil, which is not shown, and glued to one another. Furthermore, the flaps 6 and 7 are pivoted about a bending line 11 shown in dashed lines and can thus be adhered to a substrate, for example a plate, wherein the flaps 6 and 7, starting from a central plane of the decorative figure 1 extending through the adhesive surfaces, protrude to opposite sides at an angle, in particular substantially perpendicularly. The flaps 6 and 7 are pivoted approximately at right angles about the respective bending line 11.

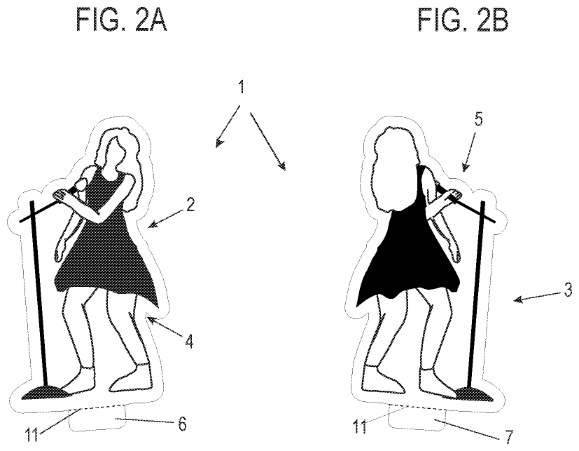

FIGS. 2A and 2B show another embodiment of two gel sticker parts 2 and 3, in which a female singer is depicted. The image 4 on the first gel sticker part 2 shows a front side of the singer, in which her hands and microphone are visible in addition to her face. On the gel sticker part 3, a back side of the singer is shown on the image 5, in which the hair and the back are visible. Flaps 6 and 7 are formed on the gel sticker parts 2 and 3, respectively, by means of which the gel sticker parts 2 and 3 can be fixed to a base.

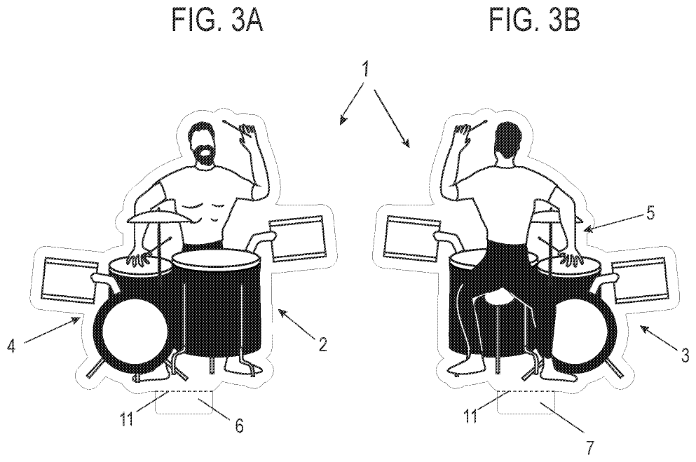

FIGS. 3A and 3B show another embodiment of two gel sticker parts 2 and 3, with a drummer as a figure in the image. The first gel sticker part 2 shows the image 4 with the front side, with the face of the drummer and the drum set from a front side. On the second gel sticker part 3 is printed the image 5 showing the back of the drummer and the view of the drums from the opposite side. A flap 6 is formed on the gel sticker part 2 and the flap 7 is formed on the gel sticker part.

Several decorative figures 1 can be fixed to a common substrate to form a decorative arrangement. Optionally, each decorative figure 1 can also be fixed to a single support so that the decorative figure 1 can be moved together with the support after it has been glued on.

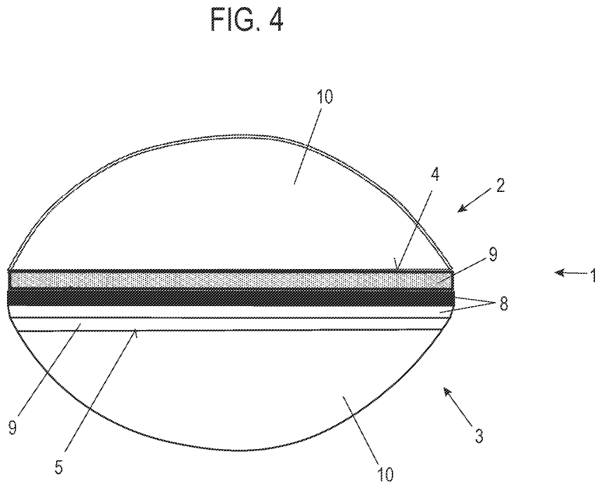

FIG. 4 shows a section through the decorative figure 1. The first gel sticker part 2 comprises a printed decorative foil 9 on which the image 4 of a front side is printed. The decorative foil 9 is coated with a transparent coating 10, which extends in an arcuate shape in section and covers the image 4. The coating 10 may be made of a polyurethane or other elastic plastic. On the side opposite to the coating 10, the decorative foil 9 is provided with an adhesive layer or adhesive surface 8. The adhesive surface 8 may be applied over the entire surface or in sections.

The second gel sticker part 3 also has a decorative foil 9 with an adhesive surface 8, wherein the image 5 of a back of the three-dimensional figure is printed on the opposite side to the adhesive surface 8. The image 5 is covered with a transparent coating 10.

The thickness of the coating 10 can be between 0.3 mm to 5 mm, in particular 0.6 mm to 3 mm, in the thickest area. In the foldable area between a flap 6 or 7 and the part with the image, the thickness may be reduced to facilitate folding of the flap 6 or 7. It is optionally possible to select the thickness of the coating to be even thicker or even thinner.

The decorative figures 1 can consist as a set of two gel sticker parts 2 and 3, which have the same size in plan view. Even if the gel sticker parts 2 and 3 are not symmetrical, they can overlap each other in such a way that no adhesive surface 8 protrudes when the two gel sticker parts 2 and 3 are stuck together.

The decorative figures 1 can be provided as a set, with the individual gel sticker parts 2 and 3 of a decorative figure 1 being adhered to a carrier foil. This means that several decorative figures 1 can be stocked on a carrier foil at the same time.

In the embodiments shown, each gel sticker part 2 and 3 has a flap 6 or 7. It is also possible to provide two flaps 6 or 7 for larger gel sticker parts 2 and 3 or to change the geometry of the flaps 6 or 7.

Although only a few embodiments of the present invention have been shown and described, it is to be understood that many changes and modifications may be made thereunto without departing from the spirit and scope of the invention.

### LIST OF REFERENCE SIGNS

1 decorative figure
2 gel sticker part
3 gel sticker part
4 image
5 image
6 flap
7 flap
8 adhesive surface
9 decorative foil
10 coating
11 bending line

What is claimed is:

1. A decorative figure comprising a first gel sticker part and a second gel sticker part which adhere to one another on an adhesive surface of each of the first and second gel sticker parts, wherein the first gel sticker part has a decorative side with an image of a front side of a three-dimensional figure and the second gel sticker part has a decorative side with an image of a back side of the three-dimensional figure, wherein a pivotable first flap is provided on the first gel sticker part and a pivotable second flap is provided on the second gel sticker part, and wherein the first flap and the second flap are configured to be fixed to a base, and the decorative side on the first and the second gel sticker parts are fixable to the base so as to project upwards.

2. The decorative figure according to claim 1, wherein the flaps are oriented substantially perpendicular to the decorative side when the decorative figure is in an erected position.

3. The decorative figure according to claim 1, wherein the flaps protrude to opposite sides starting from a plane formed by the adhesive surfaces.

4. The decorative figure according to claim 1, wherein the flaps are substantially rectangular in shape.

5. The decorative figure according to claim 1, wherein the three-dimensional figure is formed as a human, animal or plant.

6. The decorative figure according to claim 1, wherein the first gel sticker part and the second gel sticker part have the same size.

7. The decorative figure according to claim 1, wherein each gel sticker part comprises a printed decorative foil and a transparent coating.

8. The decorative figure according to claim 7, wherein the coating is applied to the decorative foil in an arcuate cross-section.

9. The decorative figure according to claim 1, wherein the first and/or second gel sticker part has a plurality of flaps.

10. A set with several decorative figures according to claim 1, wherein the individual gel sticker parts of each decorative figure are glued onto a carrier foil.
